(19) United States
(12) Patent Application Publication
(10) Pub. No.: US 2017/0045112 A1
(43) Pub. Date: Feb. 16, 2017

(54) TORQUE TRANSMITTING SYSTEM WITH TORSIONAL VIBRATION ABSORPTION FOR A POWERTRAIN

(71) Applicant: GM GLOBAL TECHNOLOGY OPERATIONS LLC, Detroit, MI (US)

(72) Inventors: Dongxu Li, Troy, MI (US); Kumaraswamy V. Hebbale, Troy, MI (US)

(73) Assignee: GM GLOBAL TECHNOLOGY OPERATIONS LLC, Detroit, MI (US)

(21) Appl. No.: 15/194,596

(22) Filed: Jun. 28, 2016

Related U.S. Application Data
(60) Provisional application No. 62/205,090, filed on Aug. 14, 2015.

(51) Int. Cl. F16F 15/123; F02D 17/02; F02B 75/18; F16H 45/02; F16D 28/00

(52) U.S. Cl. CPC F16F 15/12353; F16H 45/02; F16D 28/00; F02B 75/18; F02D 17/02

(57) ABSTRACT

A system for absorbing vibration and transmitting torque from a rotating power source to a rotatable load includes a rotatable driving member configured as an input to be driven by the power source. The system also includes a rotatable driven member configured to be driven by the driving member via a fluid coupling of the driven member to the driving member. The system also has a rotatable component configured as an output to drive the load, and a centrifugal pendulum absorber attached to the rotatable component. A first resilient member connects the driven member to the rotatable component.

### CROSS-REFERENCE TO RELATED APPLICATION

This application claims the benefit of U.S. Provisional Application No. 62/205,090, filed Aug. 14, 2015, which is hereby incorporated by reference in its entirety.

### TECHNICAL FIELD

The present teachings generally include a system for absorbing vibration while transmitting torque, such as a torque converter assembly.

### BACKGROUND

A torque converter is a hydrodynamic unit that transfers torque between an engine and a transmission and enables decoupling of the engine and transmission. The torque converter generally includes a torque converter pump portion (driving member), a turbine portion (driven member), and a stator portion that are disposed in a housing full of hydraulic fluid. The torque converter pump portion turns with a crankshaft of an engine. The turbine portion is typically connected to a transmission input shaft. A fluid coupling of the turbine portion and the pump portion can be achieved to transfer torque through the torque converter. At relatively low ratios of the speed of the turbine portion to the speed of the pump portion, redirection of hydraulic fluid within the torque converter causes torque multiplication. A torque converter clutch can be applied to mechanically transfer torque through the torque converter, bypassing the fluid coupling. Generally, it is desirable to apply the torque converter clutch at the lowest engine speed possible to increase efficiency.

One solution to absorb engine vibration once the torque converter clutch is engaged is centrifugal pendulum absorbers (CPAs), sometimes referred to as centrifugal pendulum vibration absorbers (CPVAs), include pendulum masses secured to a rotating portion of the torque converter. The pendulum masses oscillate as the rotating portion rotates, counteracting torque fluctuations caused by engine operation and thereby reducing the torsional vibration of the rotating portion, such as vibration that may occur after the torque converter clutch is engaged. CPVAs can be designed such that the oscillation frequency of the pendulum mass matches the engine combustion frequency for only one firing order mode of the engine. However, engines can be designed to have multiple modes for increased efficiency, including modes in which one or more of the cylinders are deactivated (i.e., do not fire or produce work during the deactivation). The various modes create a variety of vibration patterns that must be managed.

### SUMMARY

A system for absorbing vibration and transmitting torque from a rotating power source to a rotatable load includes a rotatable driving member configured as an input to be driven by the power source. The system also includes a rotatable driven member configured to be driven by the driving member via a fluid coupling with the driving member. The system also has a rotatable component configured as an output to drive the load, and a centrifugal pendulum absorber attached to the rotatable component. A first resilient member connects the driven member to the rotatable component.

The system may also include a second resilient member connected to the rotatable component, and a clutch that is selectively engageable to connect the driving member to the second resilient member in one embodiment, and to the rotatable component in another embodiment, thus providing a torque path from the power source to the load, via the second resilient member and the rotatable component with the centrifugal pendulum absorber thereon when the clutch is engaged. This torque path bypasses the fluid coupling between the driving member and the driven member.

An electronic controller may be operatively connected to the clutch and configured to command engagement of the clutch under predetermined operating conditions. For example, under conditions in which torque multiplication is not needed and the fluid coupling decreases operating efficiency, the clutch may be engaged. The second resilient member will provide some vibration absorption. The centrifugal pendulum absorber and the driven member (via the first resilient member) also work in tandem to absorb vibration of the rotatable component, and thus also of the driven load connected to the rotatable component.

In one embodiment, at least one of the first resilient member and the second resilient member is a coil spring. For example, the second resilient member may be a plurality of coil springs each arranged to arc about an axis of rotation of the rotatable component, and may be positioned in series, or in multiple rows. Additional damping and vibration absorbing components may be placed in series or in parallel with the system between the power source and the load, such as in series or parallel with the first resilient member.

The system may be for a powertrain in an automotive vehicle, or a non-automotive vehicle, such as a farm vehicle, a marine vehicle, an aviation vehicle, etc. It is to also be appreciated that the system can be included in appliances, construction equipment, lawn equipment, etc., instead of vehicles.

The driven member thus dynamically absorbs torsional vibration of the rotatable component via the first resilient member. For example, the first resilient member may be configured to isolate torsional vibration of the rotatable component at one predetermined vibration frequency of the rotatable component. The centrifugal pendulum absorber, by contrast, absorbs torsional vibration over an entire range of angular frequencies of the rotatable component if it is tuned for a particular engine operation mode. A peak amplitude of vibration of the rotatable component is lowered by use of the centrifugal pendulum absorber. This may enable lockup of the clutch at a lower angular frequency of the drive member, increasing fuel efficiency in a vehicle powertrain application. Additionally, by using both the centrifugal pendulum absorber and the driven member with the first resilient member attached to the rotatable component, the mass of the centrifugal pendulum absorber may be less than if only a centrifugal pendulum absorber were used to meet the same vibration performance target.

In one example of a vehicle application, a torque converter assembly is configured for absorbing vibration and transmitting torque from an engine output member to a transmission input member. The torque converter assembly includes a pump portion configured to be driven by the engine output member, a turbine portion configured to be driven by the pump portion (via a fluid coupling of the pump portion with the turbine portion), and a rotatable component configured as an output to drive the transmission input member. A centrifugal pendulum absorber is attached to the rotatable component, and a first resilient member connects the turbine portion to the rotatable component, the turbine portion thus dynamically absorbing torsional vibration of the rotatable component via the first resilient member in tandem with the centrifugal pendulum absorber when a clutch is engaged to transmit torque from the pump portion to the rotatable component.

The above features and advantages and other features and advantages of the present teachings are readily apparent from the following detailed description of the best modes for carrying out the present teachings when taken in connection with the accompanying drawings.

### BRIEF DESCRIPTION OF THE DRAWINGS

FIG. 1 is a schematic illustration of a vehicle with a powertrain including a torque converter assembly.

FIG. 2 is a schematic illustration of the torque converter assembly included in the powertrain of FIG. 1, arranged to illustrate torque flow paths.

FIG. 3 is a schematic diagram of a portion of the torque converter assembly of FIG. 2.

FIG. 4 is a schematic diagram of another portion of the torque converter assembly of FIG. 2.

FIG. 5 is a plot of torsional vibration in decibels (dB) at a transmission output member of the powertrain versus frequency in Hertz (Hz) of the engine firing vibration on the horizontal axis.

FIG. 6 is a plot of root mean square of the speed of vibration in revolutions per minute (rpm) of the transmission output member versus engine speed in revolutions per minute (rpm) for the powertrain of FIG. 1 including the torque converter assembly, and showing a plot of root mean square of the speed of vibration in revolutions per minute (rpm) versus engine speed in revolutions per minute (rpm) for a conventional torque converter assembly.

FIG. 7 is a plot of root mean square of the speed of vibration in revolutions per minute (rpm) of the transmission output member versus engine speed in revolutions per minute (rpm) for the powertrain of FIG. 1 in comparison to other configurations.

FIG. 8 is a schematic illustration of a four cylinder in-line engine in a four cylinder mode.

FIG. 9 is a plot of torque at the engine output member of FIG. 2 versus engine crank angle for the engine in the four cylinder mode of FIG. 8.

FIG. 10 is a schematic illustration of the engine of FIG. 8 in a two cylinder mode.

FIG. 11 is a plot of torque at the engine output member of FIG. 2 versus engine crank angle for the engine in the two cylinder mode of FIG. 10.

FIG. 12 is a schematic illustration of a vehicle with a powertrain including an alternative embodiment of a torque converter assembly within the scope of the present teaching.

### DETAILED DESCRIPTION

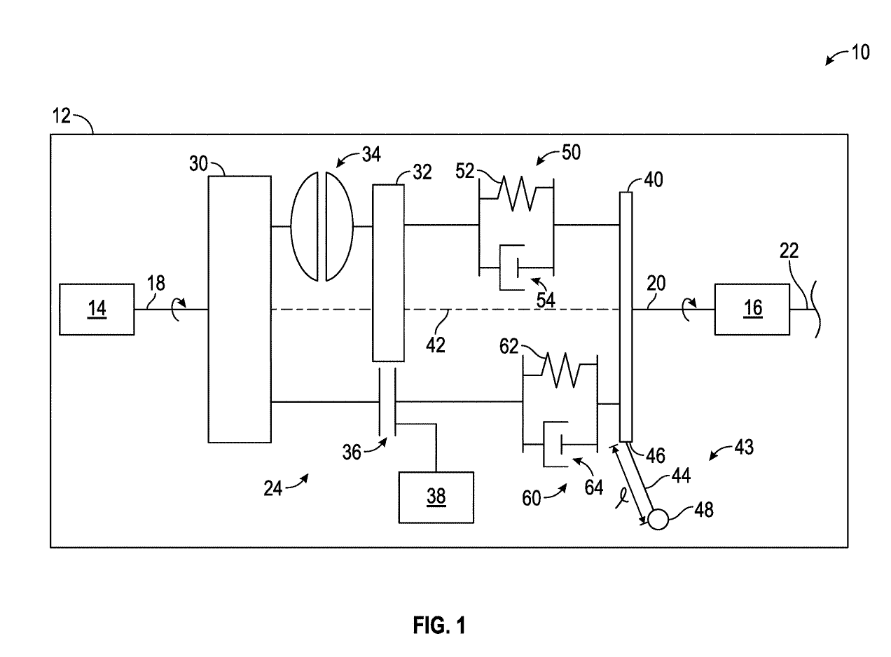

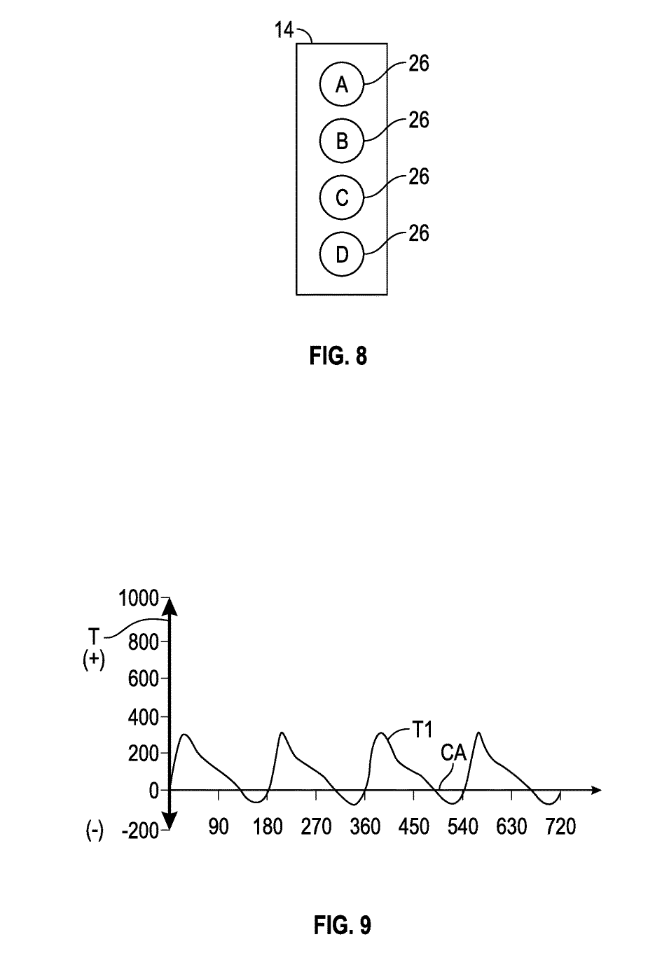

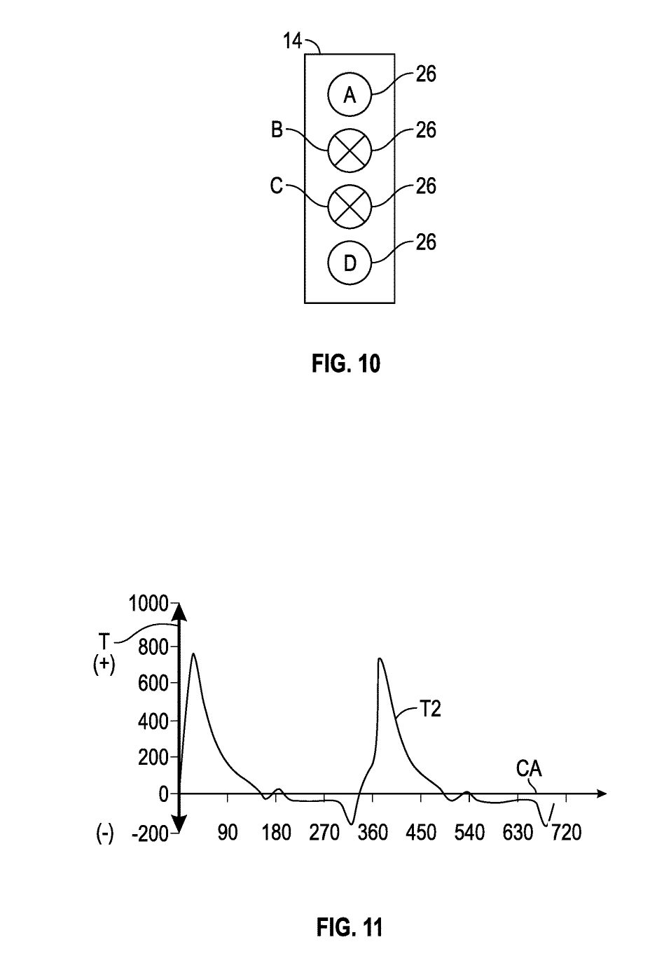

Referring to the drawings, wherein like reference numbers refer to like components throughout the views, FIG. 1 shows a vehicle 10 having a powertrain 12. The powertrain 12 is operable to provide motive power to propel the vehicle 10. The powertrain 12 includes a power source 14, such as an engine. The engine 14 may be any type of engine, such as a spark ignition engine, a compression ignition engine, or otherwise. Moreover, the engine 14 may be any layout or configuration, and may have any number of cylinders. In FIGS. 8 and 10, for purposes of example only, the engine 14 is depicted as an inline, four cylinder engine with selectively deactivatable cylinders 26 allowing the engine 14 to be operated in either a four cylinder mode or a two cylinder mode.

The powertrain 12 also includes a load driven by the power source 14. The load is represented by a transmission 16. In other words, rotational torque at an engine output member 18, such as a crankshaft, is transferred to a transmission input member 20. The transmission 16 is operable to vary the speed ratio between the transmission input member 20 and a transmission output member 22 that provides driving torque to vehicle wheels (not shown). The transmission 16 may be an automatic transmission, a manual transmission, an automated manual transmission, and may have any layout or configuration.

The powertrain 12 includes a system 24 for absorbing vibration and transmitting torque from a rotating power source, such as the engine crankshaft 18 to a rotatable load as represented by the transmission input member 20. In the application shown, the system 24 is referred to as a torque converter assembly 24. It should be appreciated, however, that the system may be used in non-automotive and/or non-vehicle applications to absorb vibration and transmit torque between a rotating power source and a rotating load as discussed herein. The system 24 may be for a powertrain in an automotive vehicle, or a non-automotive vehicle, such as a farm vehicle, a marine vehicle, an aviation vehicle, etc. It is to also be appreciated that the system can be included in appliances, construction equipment, lawn equipment, etc., instead of vehicles.

Torque generated by a rotating power source may exhibit torsional vibration such as a harmonically varying rotational speed, the magnitude of which may vary depending upon the rotational speed. As is understood by those skilled in the art, an engine 14 relying on combustion to generate torque exhibits torsional vibration at the crankshaft 18 due to the spaced firing order in the engine cylinders. For example, FIG. 8 depicts the engine 14 with four cylinders 26 labelled A, B, C, D, each of which are fired in a selected firing sequence in a four cylinder mode of operation of the engine 14. An example plot T1 showing periodic torque T in Newton-meters (Nm) at the engine crankshaft 18 on the vertical axis versus crank angle rotation (CA) on the horizontal axis from 0 to 720 degrees rotation of a four stroke cycle of the engine 14 is illustrated in FIG. 9. In other words, the magnitude of the torque T1 varies with the crank angle (angle of rotation). Four peaks in torque shown in plot T1 are associated with the combustion cycle of the four cylinders 26.

Some modern engines are operable in different operating modes in which the number of cylinders activated, the valve lift, or the valve timing may be varied depending on vehicle operating conditions, such as to increase fuel efficiency. If an engine is operable in more than one mode, a different periodic torque may result at the crankshaft 18. For example, the engine 14 is shown in FIG. 10 is operated in a two cylinder mode, with only cylinders A and D firing in a timed order, and with cylinders B and C deactivated (i.e., not fueled or fired). An example resulting plot of periodic torque T2 at the engine crankshaft 18 on the vertical axis versus crank angle rotation (CA) from 0 to 720 degrees of rotation over a four stroke cycle of the engine 14 is shown in FIG. 11. The periodic torque T2 is different in magnitude and period from the periodic torque during the four-cylinder mode. Only two peaks in periodic torque T2 result from the combustion cycle in each of the two active cylinders A, D.

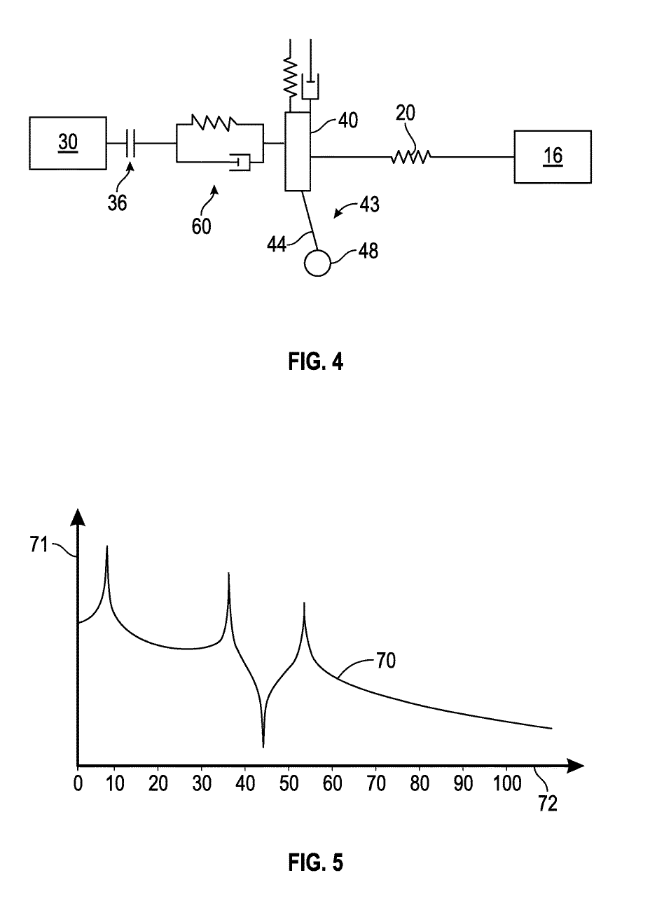

With reference to FIGS. 1-4, an improved torque converter assembly 24 enhances vibration absorption management. The torque converter assembly 24 includes a rotatable driving member, also referred to herein as a pump portion 30 configured as an input to be driven by the power source (engine 14). The pump portion 30 may be driven by the engine 14 via a connection to the engine crankshaft 18 such as by a flywheel and flex plate connection (not shown). The torque converter assembly 24 further includes a rotatable driven member, referred to herein as a turbine portion 32 configured to be driven by the pump portion 30 via a fluid coupling 34 of the pump portion 30 to the turbine portion 32. As is well understood by those skilled in the art, a torque converter can be configured to establish a fluid coupling of a pump portion to a turbine portion through fluid contained in the torque converter assembly 24. The torque converter assembly 24 has one or more cover portions surrounding the components between the crankshaft 18 and the transmission input member 20 and to contain the fluid between the pump portion 30 and the turbine portion 32. Torque transfer via the fluid coupling 34 multiplies torque from the pump portion 30 to the turbine portion 32 at low speed ratios of the speed of the transmission input member 20 to the speed of the crankshaft 18. There is some slippage through the fluid coupling 34, which decreases fuel economy. Accordingly, a torque converter clutch 36 is placed in parallel with the fluid coupling 34 and is selectively engageable to establish torque transfer from the pump portion 30 through the torque converter assembly 24 to the transmission input member 20 along a mechanical path that bypasses the fluid coupling 34. More specifically, an electronic controller 38 is operatively connected to the torque converter clutch 36 and engages the clutch 36 under predetermined operating conditions of the powertrain 12. The predetermined operating conditions under which the controller 38 commands engagement of the torque converter clutch 36 are provided to the controller 38 from various sensors or other components (not shown) configured to determine operating conditions. The operating conditions may include, but are not limited to, torque or speed of the crankshaft 18, torque or speed of the transmission input member 20, a speed differential between the pump portion 30 and the turbine portion 32, vehicle speed, and a commanded engine operating mode.

The fluid coupling 34 of the pump portion 30 and the turbine portion 32 is useful for damping engine vibrations and multiplying torque at relatively low speeds of the transmission input member 20. However, slip of the fluid coupling 34 decreases efficiency. Accordingly, the electronic controller 38 locks the torque converter clutch 36 at a relatively low speed of the transmission input member 22 and when slip (i.e., the difference in rotational speed of the pump portion 30 and the turbine portion 32 of the fluid coupling 34) is below a predetermined level to establish a mechanical connection to the rotatable component 40 rather than via a fluid coupling 34.

The torque converter assembly 24 includes a rotatable component 40 configured as an output of the torque converter assembly 24 to drive the transmission input member 20. In other words, the rotatable component 40 is directly connected with the transmission input member 20. It should be appreciated that the turbine portion 32 is not directly connected to the transmission input member 20. The rotatable component 40 may be configured as a plate, as a shell, or otherwise, and is rotatable about a common axis of rotation 42 of the pump portion 30 and the turbine portion 32. It should be appreciated that the torque converter assembly 24 is shown schematically in FIG. 1 to represent the order of components in torque flow between the crankshaft 18 and the transmission input member 20. However, the components may have different shapes and relative sizes than shown.

The torque converter assembly 24 includes a centrifugal pendulum absorber 43 that has a pendulum 44 with an end 46 attached to the rotatable component 40 at a suspension point such that the pendulum 44 is suspended from the rotatable component 40. The pendulum 44 has a mass 48 that oscillates in a plane perpendicular to the axis of rotation 42 of the rotatable component 40 as the rotatable component 40 rotates. In FIG. 1, only one pendulum 44 is shown, and the mass 48 is shown angled outward from the rotatable component 40. The centrifugal pendulum absorber 43 may have multiple pendulums 44 that may be spaced about the rotatable component 40 equidistant from the axis of rotation 42. Additionally, the location on the rotatable component 40 at which the end 46 is attached as well as the length 1, the mass 48 and the number of pendulums 44 can be selected to so that the pendulums 44 damp vibration at all rotational speeds of the rotatable component 40 under a given mode of operation of the engine 14; i.e., for a given firing order and a given number of active cylinders 26.

The torque converter assembly 24 also includes a first resilient member 50 connecting the driven member, i.e., the turbine portion 32, to the rotatable component 40. Although shown extending lengthwise between the turbine portion 32 and the rotatable component 40 parallel to the axis of rotation 42 for clarity in the schematic drawing, the resilient member 50 may be a coil spring arranged lengthwise in an arc about the axis of rotation 42. In FIG. 1, the first resilient member 50 is represented with both a spring symbol 52 and a damper symbol 54, as the first resilient member 50 is both a vibration absorber due to the spring function and a damper due to friction between the spring and the turbine portion 32 or between the spring and the rotatable component 40.

The torque converter assembly 24 also has a second resilient member 60 connected to the rotatable component 40. When the torque converter clutch 36 is engaged, either fully or with a reference slip (i.e., a controlled amount of slip between the turbine portion 30 and the rotatable component 40), the pump portion 30 is connected to the rotatable component 40 thus providing a torque path from the power source (i.e., the engine 14) to the load (i.e., the transmission 16), via the second resilient member 60 and the rotatable component 40 with the centrifugal pendulum absorber 43 thereon, bypassing the fluid coupling 34 between the pump portion 30 and the turbine portion 32. Although shown extending lengthwise between the clutch 36 and the rotatable component 40 parallel to the axis of rotation 42 for clarity in the schematic drawing, the second resilient member 60 may be a coil spring arranged lengthwise in an arc about the axis of rotation 42. In FIG. 1, the second resilient member 60 is represented with both a spring symbol 62 and a damper symbol 64 as the second resilient member 60 is both a vibration absorber due to the spring function and a damper due to friction between the spring and the rotatable component 40. The second resilient member 60 may be referred to as the torque converter clutch damper as it provides some damping of engine vibrations when the torque converter clutch 36 is locked. Packaging limitations may prevent use of a very long spring damper for the second resilient member 60, such as one or more springs arranged in series in an arc. Long spring dampers allow vibration damping with springs having a lower spring rate (i.e., softer springs) over a greater range of engine speeds than a stiffer spring, providing greater comfort, with a tradeoff of slower response to accelerator pedal tip-in.

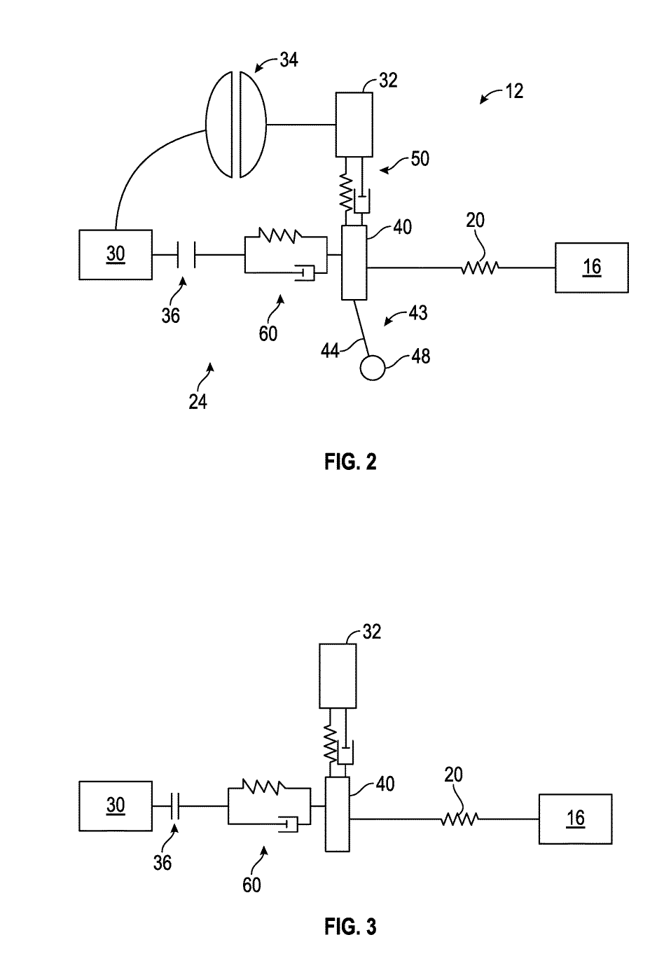

FIG. 2 shows some of the components of the powertrain 12 arranged functionally relative to one another rather than in relative positional arrangements of FIG. 1. More specifically, FIG. 2 indicates the parallel nature of a first torque flow path from the pump portion 30 through the fluid coupling 34 to the turbine portion 32, and a second torque flow path through the torque converter clutch 36 (when fully or partially engaged) to the rotatable component 40. When torque flow is through the fluid coupling 34, the majority of the torsional vibration is damped by the fluid coupling 34. Some additional vibration absorption may occur between the turbine portion 32 and the rotatable component 40 via the first resilient member 50. The transmission input member 20 is depicted as a spring in FIGS. 2-4 due to the torsional vibration absorption ability of an elongated shaft.

When the torque converter clutch 36 is engaged, torque flow is from the engine 14 through the pump portion 30, clutch 36, and the second resilient member 60 to the rotatable component 40. Because the turbine portion 32 is not coupled to the pump portion 30 in the same manner as the rotatable component 40, it may have a different rotational speed than the rotatable component 40 relative to the pump portion 30. This allows the turbine portion 32 to function as a torsional vibration absorber relative to the rotatable component 40. The first resilient member 50 can be tuned so that the turbine portion 32 isolates torsional vibration of the rotatable component 40 at a predetermined vibration frequency of the rotatable component 40. FIG. 5 illustrates a representative plot 70 of the frequency response of torsional vibration 71 of the powertrain 12 in decibels (dB) on the vertical axis, as measured at the transmission output member 22 of FIG. 1, versus frequency 72 in Hz of the engine firing vibration on the horizontal axis. The plot 70 results when the torque converter assembly 24 is used and the first resilient member 50 is tuned to isolate torsional vibration at a frequency of 44 Hz, as one example. Operation of the turbine portion 32 relative to the rotatable component 40 when the torque converter clutch 36 is locked is shown in FIG. 3. When the torque converter clutch 36 is engaged, the turbine portion 32 thus dynamically damps torsional vibration of the rotatable component 40 via the first resilient member 50.

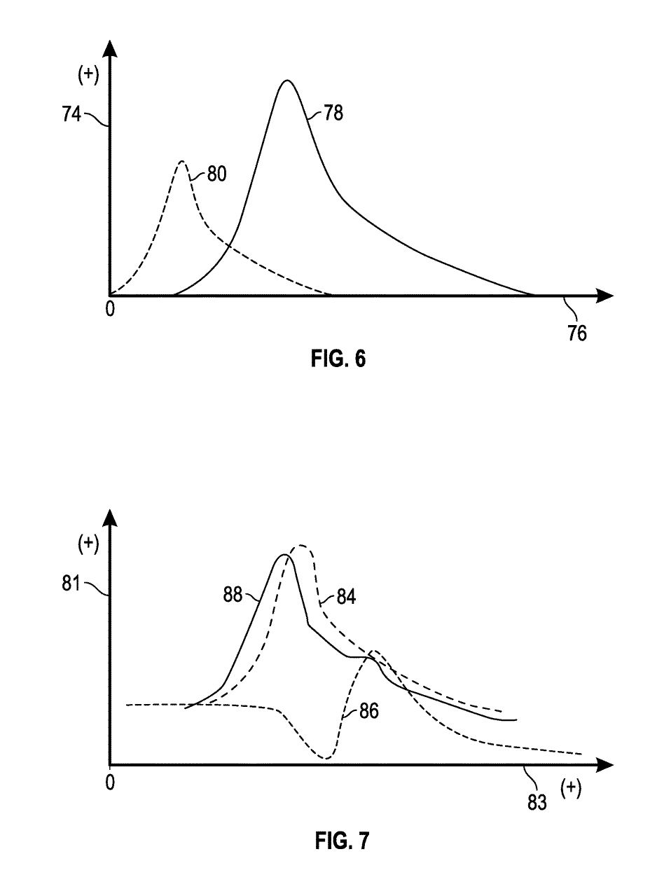

In contrast, the centrifugal pendulum absorber 43 absorbs torsional vibration of the rotatable component 40 over an entire range of engine speeds, but only for one firing order of the cylinders 26 (i.e., only for one engine operating mode). FIG. 6 illustrates representative plots of the root mean square of the speed of vibration in revolutions per minute (rpm) 74 on the vertical axis, as measured at the transmission output member 22 in FIG. 1, versus engine speed 76 in rpm on the horizontal axis (increasing to the right). Plot 78 is for a powertrain 12 with a torque converter assembly 24 like that of FIG. 1 but without the first resilient spring 50 or the pendulum vibration absorber 43, and plot 80 is for a torque converter assembly like that of FIG. 1, including only the pendulum vibration absorber 43 (and not the first resilient spring 50). The centrifugal pendulum absorber 43 as positioned on the rotatable component 40 thus allows a reduction in peak vibration and a movement of peak vibration to a lower engine speed (as indicated by the lower peak of plot 80 occurring at a lower engine speed), enabling torque converter clutch lockup at a lower engine speed. The centrifugal pendulum absorber 43 can be optimized to absorb torsional vibration associated with only one particular firing order of the engine cylinders, and is therefore limited in its ability to effectively absorb engine vibration patterns during other engine modes (i.e., other cylinder firing orders, modes in which one or more of the cylinders are deactivated, etc.).

The arrangement of the turbine portion 32 connected to the rotatable component 40 via the first resilient member 50, and with the centrifugal pendulum absorber 43 also acting on the rotatable component 40 thus enables complete isolation of engine vibration at a selected frequency (via the turbine portion 32 and the first resilient member 50) while also allows a reduction in peak vibration amplitude and a movement of peak amplitude to a lower engine speed with vibration absorption over a broad range of engine speeds (via the centrifugal pendulum absorber 43), enabling torque converter clutch lockup at a lower engine speed.

By rearranging the turbine portion 32 to be free-hanging relative to the rotatable component 40 when the torque converter clutch 36 is engaged, and isolated from (i.e., not directly connected to) the transmission input member 20, torsional vibration through a different torque path created when the torque converter clutch 36 is engaged can be affected by tuning the first resilient member 50 to completely absorb vibration at a specific angular frequency of the rotatable component 40. The freedom to tune the first resilient member 50 is greater than in an arrangement in which a centrifugal pendulum absorber is on an intermediate plate between two resilient members, i.e., with one of the resilient members between the pump portion and the intermediate plate and the other of the resilient members between the intermediate plate and the turbine portion. In such an arrangement, all components are in a linear torque flow path from the pump portion to the transmission input member and therefore the turbine portion and the resilient member connected to the turbine portion do not have a degree of freedom relative to the transmission input member (i.e., neither is free hanging).

FIG. 7 illustrates the combined effect of the torque converter assembly 24 on the root mean square of the speed of vibration in revolutions per minute (rpm) 81 at the transmission output member 22 on the vertical axis versus engine speed 83 in revolutions per minute on the horizontal axis. Plot 84 shows the characteristics of a torque converter assembly arranged like that of FIG. 1 but having only the centrifugal pendulum absorber 43 on the rotatable component 40 with the transmission input member 20 connected to the rotatable component 40, and not having the tuned first resilient member 50 arranged between the turbine portion 32 and the rotatable component 40 as in FIG. 1. Plot 86 shows the characteristics of a torque converter assembly arranged like that of FIG. 1 having the tuned first resilient member 50 between the turbine portion 32 and the rotatable component 40 and with the transmission input member 20 connected to the rotatable component 40, but not having the centrifugal pendulum absorber 43. Plot 88 shows the characteristics of the torque converter assembly 24 having the combined advantages of both the centrifugal pendulum absorber 43 and the tuned first resilient member 50 between the turbine portion 32 and the rotatable component 40 with the transmission input member 20 connected to the rotatable component 40.

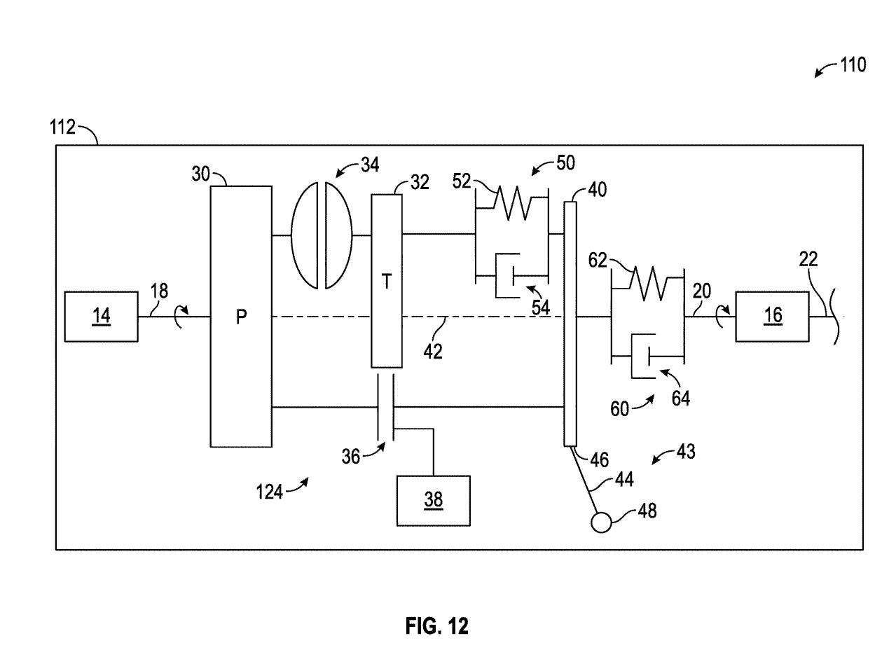

FIG. 12 is a schematic illustration of a vehicle 110 with a powertrain 112 having a system 124 for absorbing vibration and transmitting torque from the engine crankshaft 18 to the transmission input member 20. The system 124 functions in the same manner is the system 24 of FIG. 1. Identical reference numbers are used for components that are substantially identical and operate in an identical manner as described with respect to FIG. 1. The second resilient member 60 is positioned between the rotatable component 40 and the transmission input member 20, but provides the same vibration absorbing function as when positioned between the clutch 36 and the rotatable component 40 in FIG. 1.

While the best modes for carrying out the many aspects of the present teachings have been described in detail, those familiar with the art to which these teachings relate will recognize various alternative aspects for practicing the present teachings that are within the scope of the appended claims.

1. A system for absorbing vibration and transmitting torque from a rotating power source to a rotatable load, the system comprising:
a rotatable driving member configured as an input to be driven by the power source;
a rotatable driven member configured to be driven by the driving member via a fluid coupling with the driving member;
a rotatable component configured as an output of the system to drive the rotatable load;
a centrifugal pendulum absorber attached to the rotatable component; and
a first resilient member connecting the driven member to the rotatable component, the driven member thus dynamically absorbing torsional vibration of the rotatable component via the first resilient member.

2. The system of claim 1, further comprising:
a second resilient member connected to the rotatable component;
a selectively engageable clutch engageable to connect the driving member to one of the second resilient member and the rotatable component, thus providing a torque path from the power source to the load via the second resilient member and the rotatable component with the centrifugal pendulum absorber thereon when the clutch is engaged, bypassing the fluid coupling between the driving member and the driven member.

3. The system of claim 2, further comprising:
an electronic controller operatively connected to the clutch and configured to command engagement of the clutch under predetermined operating conditions.

4. The system of claim 2, wherein at least one of the first resilient member and the second resilient member is a coil spring.

5. The system of claim 1, wherein the first resilient member is configured to isolate torsional vibration of the rotatable component at one predetermined vibration frequency of the rotatable component.

6. A torque converter assembly configured for absorbing vibration and transmitting torque from an engine output member to a transmission input member, the torque converter assembly comprising:
a pump portion configured to be driven by the engine output member;
a turbine portion configured to be driven by the pump portion via a fluid coupling with the pump portion;
a rotatable component configured as an output of the torque converter assembly to drive the transmission input member;
a centrifugal pendulum absorber attached to the rotatable component; and
a first resilient member connecting the turbine portion to the rotatable component, the turbine portion thus dynamically absorbing torsional vibration of the rotatable component via the first resilient member.

7. The torque converter assembly of claim 6, wherein the first resilient member is a coil spring.

8. The torque converter assembly of claim 6, wherein the first resilient member is configured to isolate torsional vibration of the rotatable component at one predetermined frequency of the rotatable component.

9. The torque converter assembly of claim 6, further comprising:
a second resilient member connected to the rotatable component;
a selectively engageable clutch engageable to connect the pump portion to one of the second resilient member and the rotatable component, thus providing a torque path from the engine output member to the transmission input member via the second resilient member and the rotatable component with the centrifugal pendulum absorber thereon when the clutch is engaged, bypassing the fluid coupling between the pump portion and the turbine portion.

10. The torque converter assembly of claim 9, further comprising:
an electronic controller operatively connected to the clutch and configured to command engagement of the clutch under predetermined operating conditions.

11. A powertrain comprising:
an engine having a rotatable engine output member; wherein the engine has a plurality of cylinders and a plurality of operating modes in which different ones of the cylinders are deactivated;
a transmission having a rotatable transmission input member;
a torque converter assembly comprising:
a pump portion connected to and driven by the engine output member;
a turbine portion configured to be driven by the pump portion via a fluid coupling with the pump portion;
a rotatable component connected to and driving the transmission input member;
a centrifugal pendulum absorber attached to the rotatable component; and
a first resilient member connecting the turbine portion to the rotatable component, the turbine portion thus dynamically damping torsional vibration of the rotatable component via the first resilient member; and
wherein the centrifugal pendulum absorber is configured to damp vibration in one of said operating modes.

12. The powertrain of claim 11, wherein the first resilient member is a coil spring.

13. The powertrain of claim 11, wherein the first resilient member is configured to isolate torsional vibration of the rotatable component at a predetermined vibration frequency of the rotatable component.

14. The powertrain of claim 11, further comprising:
a second resilient member connected to the rotatable component.

15. The powertrain of claim 14, further comprising:
a selectively engageable clutch engageable to connect the pump portion to one of the second resilient member and the rotatable component, thus providing a torque path from the engine output member to the transmission input member via the second resilient member and the rotatable component with the centrifugal pendulum absorber thereon when the clutch is engaged, bypassing the fluid coupling between the pump portion and the turbine portion.

16. The powertrain of claim 15, wherein the second resilient member is a coil spring.

17. The powertrain of claim 11, further comprising:
an electronic controller operatively connected to the clutch and configured to command engagement of the clutch under predetermined operating conditions.
